(19) United States
(12) Patent Application Publication
(10) Pub. No.: US 2015/0145883 A1
(43) Pub. Date: May 28, 2015

(54) ALTERING ATTRIBUTES OF CONTENT THAT IS PROVIDED IN A PORTION OF A DISPLAY AREA BASED ON DETECTED INPUTS

(71) Applicant: QUALCOMM INCORPORATED, San Diego, CA (US)

(72) Inventor: Stefan Marti, Oakland, CA (US)

(73) Assignee: QUALCOMM INCORPORATED, SAn Diego, CA (US)

(21) Appl. No.: 14/391,367

(22) PCT Filed: Apr. 26, 2012
(86) PCT No.: PCT/US2012/035142

§ 371 Date: Feb. 10, 2015

(51) Int. Cl. G06T 11/00; G06F 3/01; G06T 3/40

(52) U.S. Cl. CPC G06T 11/00; G06T 3/40; G06T 11/001; G06F 3/012; G06T 2215/16
USPC 345/592; 345/660

(57) ABSTRACT

A method is disclosed for providing content on a computing device. Content is provided, from execution of an application, in a defined portion of a display area that is provided by a display device of the computing device. The defined portion includes a first set of attributes. One or more attributes of the first set of attributes is altered based on one or more inputs detected by one or more sensors. The one or more attributes are altered independent of a set of settings used by the display device to provide the display area.

### BACKGROUND OF THE INVENTION

Consumers regularly use a variety of different mobile computing devices for performing many different tasks. Because these mobile computing devices can be easily carried around by users, users can operate them at different places and locations (e.g., at home, while walking, sitting at the office, etc.). For example, the user can operate the computing device to play a game, and move the computing device as a means for controlling the game.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example system for providing content on a computing device, under an embodiment;

FIG. 2 illustrates an example method for providing content on a computing device, according to an embodiment;

FIG. 3 illustrates an example scenario of a user operating a computing device, under an embodiment;

FIGS. 4A-4B illustrate dynamic adjustments performed on a computing device, under an embodiment;

FIGS. 5A-5B illustrate dynamic adjustments performed on a computing device, under another embodiment; and

FIG. 6 illustrates an example hardware diagram for a system for providing content on a computing device, under an embodiment.

### DETAILED DESCRIPTION

Embodiments described herein provide for a computing device that is able to adjust the manner in which content is displayed based on conditions, such as user proximity, orientation, and/or surrounding environmental conditions.

More specifically, some embodiments enable a computing device to adjust how content is displayed based on various conditions and settings. The manner in how content is displayed can include, for example, geometric variations, to accommodate conditions, such as device tilt. Still further, some embodiments manipulate the content to simulate three-dimensional perspective. In variations, the display device can adjust a select portion of its content based on conditions and settings.

A display device can accommodate, for example, conditions and settings, such as the device orientation, the device orientation relative to the user, the user's position relative to the display device, lighting conditions and/or other surrounding environmental factors.

According to one or more embodiments, a computing device can be configured to include a display that is responsive to, for example, ambient light conditions surrounding the display. In an embodiment, the computing device can dynamically adjust one or more attributes of the content provided on the display, as well as one or more display settings. In particular, display settings, such as brightness, contrast, and/or saturation, can be adjusted on the display surface globally (adjust the entire display surface) as well as locally (adjust a select portion of display surface independent of other portion(s) of the display surface).

The computing device can detect various conditions based on one or more inputs detected and provided by one or more sensors of the computing device. By dynamically adjusting portions of the content and/or the display settings of the display surface, the computing device can automatically compensate for various conditions in order to provide a user with a consistent view of the content.

Various embodiments described herein can be implemented on various kinds of display devices, including computing devices such as tablets, laptops, desktop computers, mobile computing devices (e.g., cellular communication devices or smart phones), digital cameras, or media playback devices.

According to an embodiment, a processor of a computing device provides content on a display surface of the computing device. The content is provided from the execution of one or more applications that is stored in the computing device. For example, the execution of a photograph application can provide an image as content, whereas the execution of an e-mail application can provide an e-mail message as content. The content is provided in a defined portion of a display area that is provided by the display. The defined portion of the display area includes a first set of attributes. One or more attributes of the first set of attributes can be automatically altered or adjusted based on one or more inputs that are detected by one or more sensors of the computing device. The one or more attributes are altered independent of a set of settings that is used by the display to provide the display area.

In some embodiments, the one or more attributes are altered by determining a position and/or an orientation of the computing device relative to the user, or portion of the user (e.g., the user's head, finger or hand, etc.). The position of the computing device can include the distance from the user's head to the computing device when the computing device is being held by the user. The position and/or the orientation can also include, for example, an amount of tilt, skew or angular displacement as between the user (or portion of user) and the device. The determinations of various conditions can be made when the computing device is used in different operation settings, such as when the computing device is held by the user or is placed on a surface or dock. The amount of angular displacement can result in a viewing angle for the user. According to embodiments, different adjustments can be made in the display settings (global and/or local) as well as the manner in which the content is provided (e.g., geometrically, with three-dimensional perspective) based on factors that include the viewing angle. Some embodiments can utilize conditions or inputs that are detected and provided by the sensors of the computing device.

The attributes of the defined portion in which content is provided can be altered by using one or more rules that are stored in a database. The database can be stored remotely and/or locally in a memory resource of the computing device. When various conditions of the computing device and/or environmental conditions (e.g., ambient light surrounding the display) are determined via the inputs provided by one or more sensors, the processor can apply one or more rules and/or heuristics in order to determine what alterations or adjustments to perform.

Still further, in one embodiment, the one or more attributes of the defined portion can be altered by changing a size and/or shape of the defined portion in which the content is provided. The content framework, which provides content from the execution of an application, can be adjusted, for example, to simulate three-dimensional perspective. The framework can be a separate application or process than the executing application, or can be a part of the executing application. The content within the framework can also be proportionally scaled and adjusted corresponding to the changed size and/or shape of the framework. In other embodiments, the one or more attributes can be altered by automatically changing colors and/or other visual effects of the content that is provided in the defined portion of the display area.

The sensors can also detect environmental conditions, such as ambient light conditions that surround the display surface of the computing device. According to an embodiment, the ambient light conditions can include light intensities (e.g., the amount of light hitting the display surface of the display or how bright the overall surrounding is), the direction in which light is hitting the display surface, and/or the type of the ambient light sources. By using the different inputs provided by the sensors, the processor can determine the direction and the angle at which light is hitting the display surface. The processor can determine, for example, the location of a glare on the display surface using the determined ambient light conditions and can adjust a local display setting and/or the provided content in order to compensate for the ambient light conditions.

In some embodiments, the processor can alter one or more settings of the set of settings that are used by the display based on the determined conditions. Display settings can be adjusted globally (adjust the entire display surface) or locally (adjust a select portion of display surface independent of other portion(s) of the display surface) depending on the determined conditions. For example, the brightness level of a portion of the display area can be automatically adjusted (e.g., make brighter or less bright) depending on the ambient light conditions surrounding the display surface and/or depending on the way the user is holding the computing device (e.g., how far the computing device is from the user's head or how much the computing device is being tilted relative to the user).

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules or components. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as desktop computers, cellular or smart phones, personal digital assistants (PDAs), laptop computers, printers, digital picture frames, and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

As used herein, the term “substantial” or its variants (e.g., “substantially”) is intended to mean at least 75% of the stated quantity, measurement or expression. The term “majority” is intended to mean more than 50% of such stated quantity, measurement, or expression.

System Description

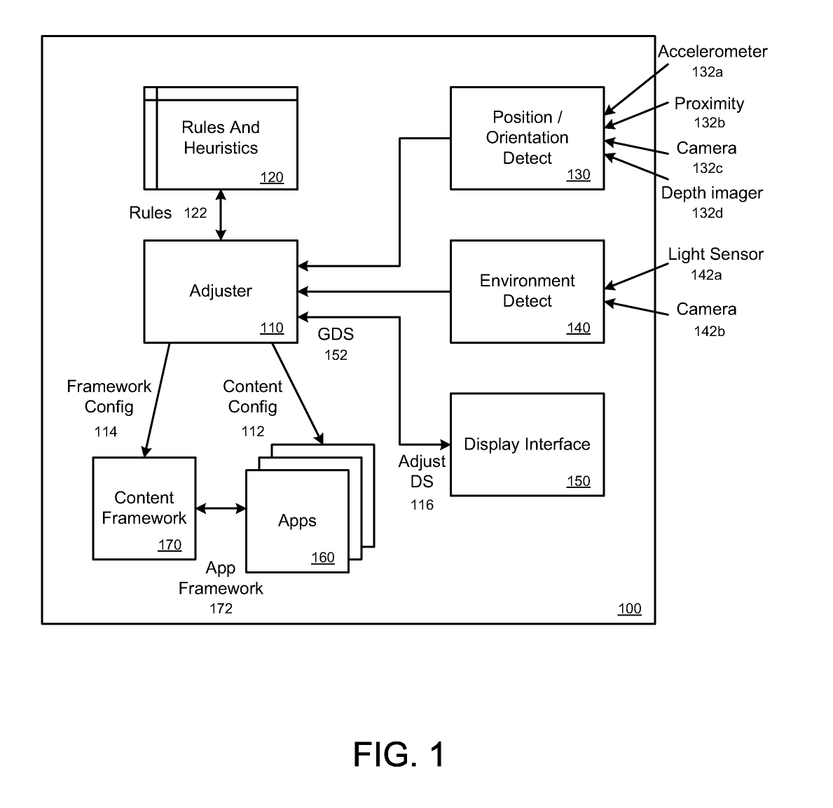

FIG. 1 illustrates an example system for providing content on a computing device, under an embodiment. A system such as described with respect to FIG. 1 can be implemented on, for example, a mobile computing device or small-form factor device, or other computing form factors such as tablets, notebooks, desktops computers, and the like. In one embodiment, system 100 determines conditions, such as the position and/or orientation of the computing device and environmental conditions, based on inputs that are detected and provided by one or more sensors of the computing device. Based on the determined conditions, system 100 dynamically alters or adjusts content that is provided on a display and/or dynamically alters one or more display settings of the display device.

According to an embodiment, system 100 includes components such as an adjuster 110, a rules and heuristics database 120, a position/orientation detect 130, an environment detect 140, and display interface 150. System 100 also includes one or more applications 160 and content framework 170. The components of system 100 combine to provide content, and to dynamically adjust portions of the content and/or one or more display settings used by the display device. The adjustments can be made in real-time, as conditions, such as ambient light conditions as well as the position and/or orientation of the computing device, can quickly change while a user operates the computing device.

System 100 can receive a plurality of different inputs from a number of different sensing mechanisms of the computing device. In one embodiment, the position/orientation detect 130 can receive input(s) from an accelerometer 132a, proximity sensor 132b, camera 132c, depth imager 132d, or other sensing mechanisms (e.g., a magnetometer, a gyroscope, and more). A computing device may also include a plurality of such described sensors, such as multiple cameras or multiple depth imagers. By receiving input from one or more sensors, the position/orientation detect 130 can determine one or more conditions relating to the computing device. For example, the position/orientation detect 130 can determine the orientation of the computing device (e.g., whether a user is holding the computing device in a landscape position, portrait position, or a position somewhere in between) as well as the distance of the user from the computing device.

In some embodiments, the position/orientation detect 130 can use the inputs that are provided by the various sensors (e.g., an accelerometer 132a, proximity sensor 132b, camera 132c, depth imager 132d) to determine where the user is relative to the device. For example, by using the inputs, the position/orientation detect 130 can determine how far the user (or the user's head or the user's finger) is from the computing device, whether the device is docked on a docking device or being held by the user, or whether the device is being tilted and in what direction(s) the device is being tilted. In some cases, a user may hold a computing device, such as a tablet device, while sitting down on a sofa, and operate the device to use one or more applications (e.g., write an e-mail using an email application, browse a website using a browser application, watch a video using a video application). The position/orientation detect 130 can determine that the device is being held by the user in a landscape orientation, for example, about a foot and a half away from the user's head.

In one embodiment, the position/orientation detect 130 uses a combination of the inputs from the sensors to determine the position, tilt, orientation, etc., of the computing device. For example, the position/orientation detect 130 can process inputs from the camera 132c and/or the depth imager 132d to determine that the user is looking in a downward angle towards the device, so that the device is not being held vertically (e.g., not being held perpendicularly with respect to the ground) or directly in front of the user. By using the inputs from the camera 132c as well as the accelerometer 132a, the position/orientation detect 130 can determine that the user is viewing the display in a particular angle, and that the device is also being held in a tilted position with the display surface of the display device facing in a partially upward direction. A comprehensive view of the conditions in which the user is operating the computing device can be determined. The system 100 can then dynamically alter portions of the content and/or local or global display settings to correct display artifacts that may exist due to varying angular displacements and tilt.

The various device and environmental conditions (e.g., position, tilt, or orientation of the device, or distance the device is being held from the user) that are determined by the position/orientation detect 130 can be used by the adjuster 110 to alter or adjust the content that is being displayed on a defined portion of a display area (that is provided by a display device). The adjuster 110 can also alter or adjust one or more settings that are used by the display device (globally and/or locally). For example, in cases where the user is not holding the computing device in an ideal position (e.g., viewing the content from an angle because the display is tilted backwards or downwards), the luminance, colors, and other display properties can be changed depending on such viewing angles. In some embodiments, system 100 can detect a plurality of users that are close to the computing device using the sensing mechanisms. System 100 can correct these display artifacts by altering portions of the content and/or settings of the display device to provide a more visually consistent rendering of the content.

In one embodiment, the environment detect 140 can receive input(s) from a light sensor 142a, a camera 142b, or other sensing mechanisms (other imagers or a plurality of sensors and cameras). The environmental detect 140 can use the inputs detected and provided by the sensors to determine an amount of light (e.g., intensity) that falls on the display surface of the display device and/or direction(s) in which the light hits the display surface. The environment detect 140 can also determine the type of light in the environment surrounding the display device. For example, the environment detect 140 can process the inputs from the sensors and determine the location of a dominant light source (e.g., the angle with respect to the display surface), such as the sun, if the user is by a window or outside, the intensity of the sun, light temperature (e.g., color tint), diffuseness, or other parameters. The detected ambient light conditions can be provided to the adjuster 110.

The determined environment conditions can be used by the adjuster 110 to configure content or portions of the content that is being displayed on a defined portion of a display area. The adjuster 110 can also alter one or more display settings either globally or locally. For example, due to the location and angle in which light falls on the display surface, a glare can exist on a location of the display surface. The adjuster 110 can alter a local portion of the display surface to make a portion of the display area be brighter than the other portions to offset such ambient light conditions that may exist. In another example, if a bright light source with high intensity is positioned behind the display and facing the user, the adjuster 110 can also alter portions of the content that is displayed on the display area to be bolder in color and have larger or bolder font.

According to an embodiment, system 100 also includes a display interface 150 that can include or store various parameters or settings (that can be fixed or adjusted by the user) for the computing device. These settings can include display settings, such as global display settings (GDS) 152 as well as other device settings. The user can change or configure the parameters manually (e.g., by accessing a settings functionality or application of the computing device) to alter various GDS 152, such as the brightness levels, color saturation, contrast, dimming of display backlights, etc., of the display device. The adjuster 110 can use GDS 152 as a basis to determine what to adjust (e.g., what portions of content and/or what particular settings) and/or how much to adjust.

System 100 includes one or more applications (and/or device functionalities) 160 that are stored in a memory of the computing device. Applications or functionalities can include a home page or start screen, an application launcher page, messaging applications (e.g., SMS messaging application, e-mail application, IM application), a phone application, game applications, calendar application, document application, web browser application, clock application, camera application, media viewing application (e.g., for videos, images, audio), social media applications, financial applications, and device settings. The content that is provided from execution of an application can change as the user interacts with the content (e.g., type in search terms, scroll through pictures, write an email).

Content can be provided on a display area of the display device as a result of the execution of one or more applications 160. The content can be provided in a content framework 170 via application framework 172. In one embodiment, the content framework 170 can provide a window or boundary in which content can be provided in. In some embodiments, the content framework 170 can be a part of the application(s) 160 or can be a separate application or process than the application(s) 160. The adjuster 110 can configure content 112 or portions of the content (that is provided by an application 160 that is operating on the computing device) based on the determined conditions. For example, if the user is operating a calendar application, the calendar application can provide calendar content (e.g., a calendar with dates and events listed) to be provided within the provided content framework 170. The adjuster 110 can configure the content 112, such as by making the colors of the rendered content brighter/bolder or changing the font size of the text on the rendered content, and/or can configure 114 the framework in which the content is provided.

The adjuster 110 can also configure 114 the framework so that the content can be simulated in a three-dimensional perspective of the user. For example, if the device is tilted in a way so that an angular displacement exists relative to the user, the shape and/or the size of the framework can be configured as a trapezoid, for example, to offset the tilt. In this way, the visual display properties can be corrected so that the user can view the content in a normalized fashion even though the device is titled forward, for example. The content framework 170 can be adjusted so that the window in which the content is provided can be adjusted (e.g., the width of the top of the content window is smaller than the width of the bottom of the content window. The content provided in the defined portion can also be scaled proportionally (to match the adjusted shape and/or size of the framework 170) using application framework 172.

The adjuster 110 can also adjust one or more global or local display settings (DS) 116. The computing device can include a plurality of device drivers, including a display driver. The display driver can allow the components of system 100 to interact with the display device. In an embodiment, the display driver can drive portions of the display individually. In this manner, the adjuster 110 can alter a select portion of display surface independent of other portion(s) of the display surface (e.g., an upper right quadrant of the display) by adjusting the brightness levels, color saturation, contrast, dimming of display backlights, etc., of only the portion of the display.

In one embodiment, the different conditions and combination of conditions that are dynamically determined by the position/orientation detect 130 and the environment detect 140 can provide a comprehensive view of the conditions in which the user is operating the computing device. Based on the conditions that are determined by the components of system 100, the adjuster 110 can access the rules and heuristics database 120 to determine one or more rules and/or heuristics 122 (e.g., look up a rule) to use in order to adjust a portion of the content 112 and/or adjust one or more display settings 114 (either global or local display settings). One or more rules can be used in combination with each other so that the adjuster 110 can adjust the manner in which content is displayed. A more consistent and constant view (from the perspective of the user) of the content can be provided despite the computing device being tilted and despite ambient light conditions surrounding the display surface.

For example, according to an embodiment, the rules and heuristics database 120 can include a rule to increase the brightness and/or contrast of a portion of the content or the content itself (the content that is provided in a defined portion or framework 170 of a display area of the display device) when the user is further away from the display surface. One or more attributes of the defined portion in which the content is displayed can be adjusted, based on this rule, by making the colors of the rendered content brighter/bolder or changing the font size of the text on the rendered content. In another example, the rules and heuristics database 120 can also include a rule to increase the brightness of a portion of the display area (e.g., adjust a local setting) or increase the brightness of the entire display area when the user is further away from the display surface (e.g., adjust a global setting). Similarly, if the user moves the display closer to her, the sensors can dynamically detect the change in distance and the position/orientation detect 130 can determine that the device is closer to the user. As a result, a rule 122 that causes the brightness of the display surface to be reduced can be applied by the adjuster 110.

In addition to the determined position and orientation of the device (e.g., tilt, distance from the user), the adjuster 110 can also select one or more rules to adjust the content and/or display settings based on the determined environmental conditions (e.g., ambient light conditions). The rules and heuristics database 120 can include rules that can cause content to be configured 112 and/or global or local display settings 115 to be adjusted. For example, the manner in which the user tilts the device can also affect the areas in which a glare exists on the display surface and can affect the position of the light sources relative to the display surface. A rule can prompt the adjuster 110 to increase the brightness setting of the display surface when the dominant ambient light source is in line with the user and the display area (e.g., the sun is approximately behind the display area and facing the user).

In another example, when a dominant ambient light source is at an angle so that it reflects on the display surface (e.g., produces a glare), a rule 122 can reduce the glare that is seen on a portion of the display surface (e.g., make the display area more or less reflective, or a portion of the display area). In one embodiment, the display area of the display device can include a material or a layer that can adjust the amount of reflectivity (e.g., make more matte or less glossy) of the display area or a portion of the display area.

Various rules that are stored in the rules and heuristics database 120 can be used in combination with each other based on the determined conditions provided by the position/orientation detect 130 and the environment detect 140. The rules and heuristics database 120 can also include one or more heuristics that the adjuster 110 dynamically learns when it makes various adjustments. Depending on different scenarios and conditions that are presented, the adjuster 110 can adjust the rules and/or store additional heuristics in the rules and heuristics database 120. In some embodiments, the user can indicate via a user input whether or not the altered content or settings is preferred or not (e.g., the user can confirm or reject automatically altered changes). After a certain number of indications rejecting a change, for example, the adjuster 110 can determine heuristics that better suit the particular user's preference. The heuristics can include adjusted rules that are stored in the rules and heuristics database 120 so that the adjuster 110 can look up the rule or heuristic when a similar scenario (e.g., based on the determined conditions) arises.

Based on the determined conditions, the adjuster 110 can select one or more rules/heuristics and can adjust a portion of the content 112, adjust the framework 114, or adjust one or more display settings 116. The adjuster 110 can alter the rendering of the content by an executed application 160 to compensate or correct variances that exist due to the determined conditions in which the user is viewing or operating the device. In some embodiments, the content or portion of the content that is provided in the content framework 170 can be altered by changing colors, images, and/or texts of the content 112. In another embodiment, one or more attributes of the framework or defined portion in which the content is provided can be changed in size and/or shape 114. The content that is provided in the framework can be proportionally scaled in a manner corresponding to the changed size and/or shape of the defined portion (e.g., change an image corresponding to the changed size or shape).

The adjuster 110 can also adjust one or more global or local display settings of a set of display settings that is used by the display device to provide the display area. The one or more display settings can include brightness, contrast, color saturation, color tint, color tone, sharpness, resolution, reflectivity, or transparency. Based on the applied rules and/or heuristics 122, the adjuster 110 can adjust one or more display settings to correct variances that exist, for example, due to the user viewing the display area in a tilted position or due to ambient light conditions. Because the sensors are continually or periodically detecting inputs corresponding to the device and corresponding to the environment, by dynamically adjusting portions of the content and/or the display settings of the display device, the computing device can automatically compensate for various conditions in order to provide a user with a consistent view of the content.

Methodology

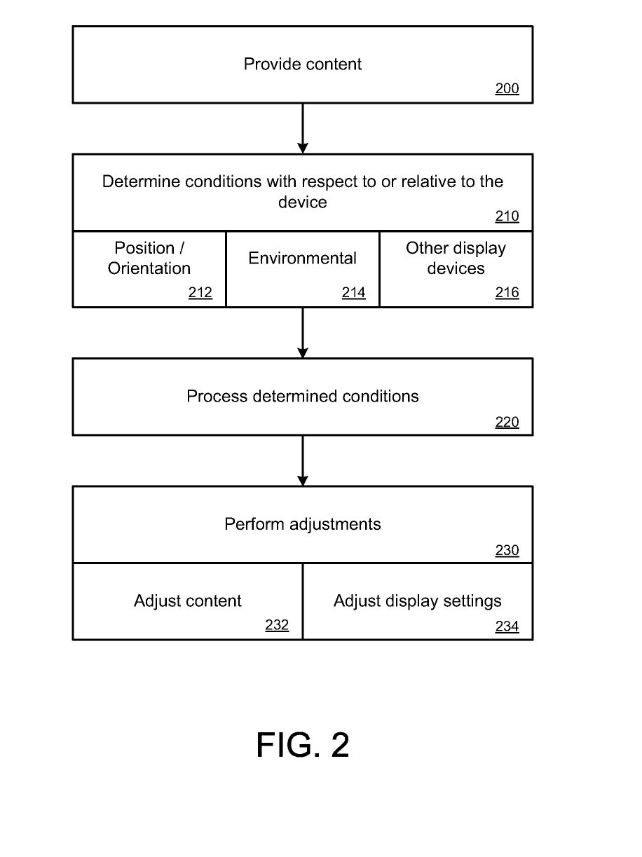

A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described. FIG. 2 illustrates an example method for providing content on a computing device, according to an embodiment.

In FIG. 2, content is provided in a defined portion or framework of a display area that is provided by the display device (step 200). The display device can be a touch-sensitive display device. The content can be provided from execution of an application or from operating a functionality or settings of the computing device. For example, the computing device can be a tablet device or smart phone in which a plurality of different applications can be operated on individually or concurrently. A user can navigate between applications and view content provided by each of the different applications.

While the user is operating the computing device, e.g., using an executed application, the processor(s) can determine one or more conditions corresponding to the manner in which the computing device is being operated or viewed by the user (step 210). The various conditions can be determined dynamically based on one or more inputs that are detected and provided by one or more sensors. The one or more sensors can include one or more accelerometers, proximity sensors, cameras, depth imagers, magnetometers, gyroscopes, light sensors, or other sensors.

According to one or more embodiments, the sensors can be positioned on different parts, faces, or sides of the computing device to better detect the user and/or ambient light. For example, a depth sensor and a first camera can be positioned on the front face of the device (e.g., on the same face as the display surface) to be able to better determine how far the user's head is from the display as well as the angle in which the user is viewing the device. Similarly, one or more cameras can be used to track a user's face, to determine the location of the user's eyes, for example, to better determine the viewing angle in which the user is viewing the display area. In another example, light sensors can be provided on multiple sides or faces of the device to better gauge the ambient light conditions surrounding the display surface and the computing device.

Based on the different inputs provided by the sensors, the processor can determine the position and orientation of the device, such as how far it is from the user, the amount the device is being tilted and in what direction the device is being tilted relative to the user, and the direction the device is facing (North or South, etc.) (sub-step 212). The processor can also determine environmental conditions (sub-step 214), such as ambient light conditions, based on the different inputs detected by the one or more sensors. Environmental conditions can include light intensities (e.g., the amount of light hitting the display surface of the device or how bright the overall surrounding is), the direction in which light is falling on the display surface, diffuseness, and/or the type of the ambient light sources. The various conditions are also determined in conjunction with global and/or local settings (or fixed display parameters) for the display device.

In some embodiments, the processor can determine whether other display devices are being used in conjunction with the display device of the computing device (sub-step 216). In addition to the sensing mechanisms described, the computing device can communicate with other devices via wires or wirelessly (e.g., Bluetooth or Wi-Fi) so that content from the computing device can also be shared or displayed on another display device (or devices). For example, when the user is using multiple display devices, in the perspective of the user, all of the display devices appear to have similar visual properties (e.g., brightness, color, etc.) even though the user will be looking at the devices from different angles (e.g., looking at the first display straight on, while looking at the second display from an angle).

The processor of the computing device processes the determined conditions in order to determine what types of adjustments, if any, need to be made (step 220). In some embodiments, the determined conditions are processed dynamically because the sensors continually detect changes in the way the user operates the device (e.g., the user moves from a brighter room to a darker room, shifts the position of the device, etc.). The determined conditions can cause variances in the way content is viewed by the user (from the perspective of the user) due to angular displacements. Based on the determined conditions, one or more rules and/or heuristics can be selected and used to determine what adjustments, if any, should be made to compensate, correct and/or normalize the visual appearance of the content from the perspective of the user. The one or more rules can be looked up in a database that is stored remotely or locally in a memory resource of the computing device. The rules may be used in combination with each other based on the determined conditions.

For example, the one or more rules can cause the adjuster to increase the brightness of local or global display settings and/or portions of the content itself (or the entire content) based on the environmental conditions and the manner in which the device is being held by the user (e.g., the amount of tilt, orientation, distance from the user). In another example, a rule can cause the transparency or reflectivity of the display settings to be altered based on the direction in which a dominant ambient light source falls on the display surface of the display area. This rule can be used, for example, to offset a glare or offset variances caused by the tile of the device with the ambient light sources surrounding the display surface.

In one embodiment, based on the determined conditions and depending on the one or more rules selected, various adjustments can be automatically performed by the adjuster (step 230). The rendering of the displayed content can be adjusted by altering one or more attributes of the content and/or the framework (attributes that are independent of the display settings used by the display device to provide the display surface) (sub-step 232). In some embodiments, the attributes of the content can be altered by changing a size and/or a shape of the framework in which the content is provided. The content can also be altered by changing colors, boldness, font size, font type, etc., of the content or portions of the content, based on the one or more rules selected by the adjuster.

According to an embodiment, one or more display settings of a set of settings used by the display device can also be adjusted independently or in conjunction with the adjusted content (sub-step 234). The one or more display settings can include brightness, contrast, color saturation, color tint, color tone, sharpness, resolution, reflectivity, or transparency. Based on the selected rules, the adjuster can adjust one or more of these display settings (either globally or locally) to correct variances that exist due to the various detected conditions (e.g., the user viewing the display area in a tilted position or due to the existence of dominant ambient light conditions shedding light on the display surface). For example, the adjuster can (based on the determined conditions and rules) adjust a portion of the display settings (e.g., make a quadrant of the display area brighter or have more contrast than the other remaining portion of the display) to offset visual artifacts caused by ambient light conditions and positioning of the device (e.g., glares on the display surface).

The adjustments can be made dynamically so that attributes of the displayed content and/or the independent display settings can be continually adjusted as the sensors constantly or periodically detect inputs that are changing. For example, the adjustments can occur in real-time as the user changes positions on his chair while operating the device or as the sun sets (or lighting dims).

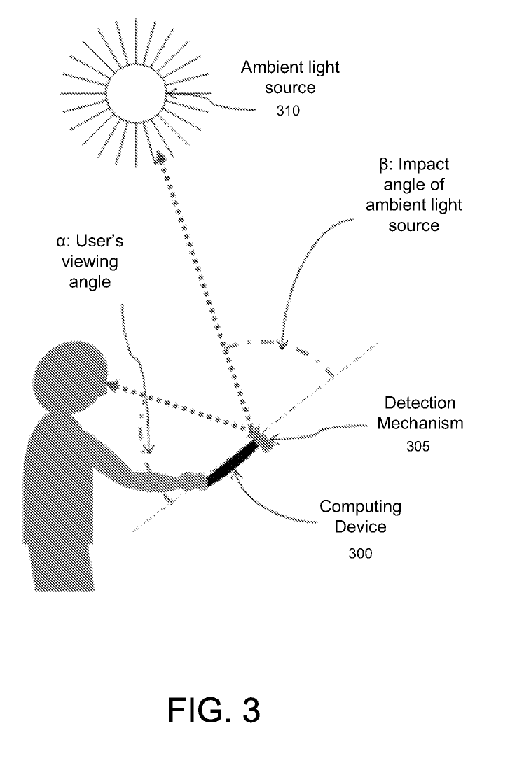

FIG. 3 illustrates an example scenario of a user operating a computing device, under an embodiment. FIG. 3 illustrates a simplified example of the computing device detecting a glare or reflection from a strong or dominant ambient light source from the user's perspective. The user is holding and viewing a computing device 300, such as a tablet device, while standing outside. The computing device 300 includes at least one detection mechanism or sensor 305, such as a camera or an imager that can track a user's face, that is positioned on the front surface of the computing device 300 (e.g., on the same face as the display surface of the display device). The dominant ambient light source 310, for example, can be the sun (or a single light bulb in a room, etc.).

Due to the manner in which the user is holding and operating the computing device 300 and the ambient light conditions surrounding the device 300, a glare from the reflection of the ambient light source 310 can exist on the display surface of the device 300. Because the user is holding the computing device 300 in a titled manner and looking in a slightly downward direction (e.g., instead of looking straight ahead with her head up), the user is viewing the display area of the display device at a certain viewing angle, approximately angle α. As a result of angular displacement, variances on the display surface can exist.

In addition, the ambient light source 310 can cause an impact angle of the ambient light hitting the surface of the display area, approximately angle β. The one or more detection mechanisms 305 can detect and provide inputs so that the computing device 300 can determine various device and environmental conditions (e.g., the position, orientation, tilt of the device, and/or the ambient light conditions). Based on the determined conditions, the computing device 300 can dynamically adjust attributes of the displayed content and/or the independent display settings for enhancing the content in the perspective of the user.

In some embodiments, the one or more detection mechanisms 305 can be on the front face of the device but not be centered exactly in the center of the device 300. In making the determination of the various conditions, such as the amount the device is tilted, the orientation of the device, the viewing angle of the user, where the user's head is with respect to the device (including where the user's eyes are with respect to the device), the location and brightness level of the ambient light source(s), etc., the computing device 300 takes into account the positioning of the detection mechanisms relative to the display area, as well as other properties of the display area (e.g., the size of the housing of the device, the size of the display surface, etc.). For example, the detection mechanism 305 can be a front facing camera that is positioned in the upper left corner of the front face of the device 300. Note that angles α and β are, in fact, 3-D vectors, so the position of the camera can affect the determination of where the glare is supposed to be on the display surface, as well as where the user's head is with respect to the display surface of the device 300.

The computing device 300 can dynamically adjust attributes of the displayed content and/or the independent display settings based on the determined conditions. For example, if the device 300 is tilted even more so that the display surface is substantially horizontal with respect to the ground or substantially vertical with respect to the ground as the user operates the device 300, the location of the glare would change. In addition to the variances due to the ambient light (e.g., due to light source 310), the positioning of the device 300 can also cause portions of the content provided in a portion of the display area to be less sharp than other portions of the display area (e.g., due to the user's viewing angle).

### Usage Examples

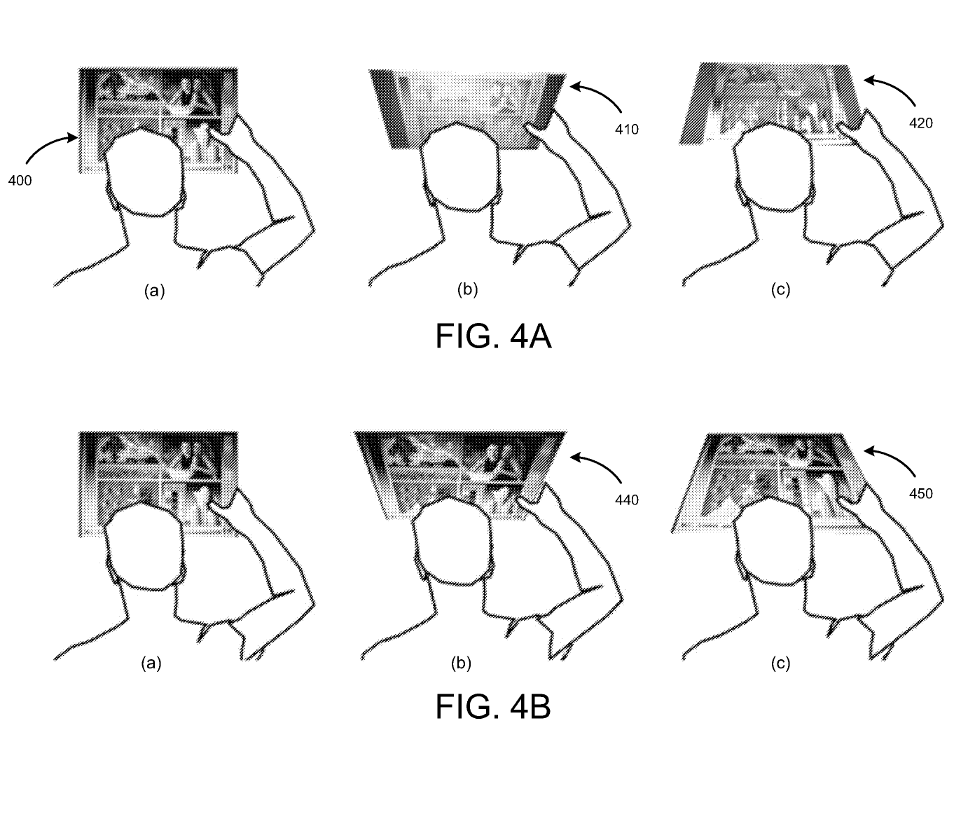

FIGS. 4A-4B illustrate dynamic adjustments performed on a computing device, under an embodiment. The exemplary illustrations of FIGS. 4A-4B represent the way a user is holding and viewing content that is provided on a display area of a computing device. The dynamic adjustments described in FIGS. 4A-4B can be performed by using the system described in FIG. 1 and methods described in FIGS. 2 and 3.

FIG. 4A illustrates three scenarios, each illustrating a different way in which the user is holding a computing device and viewing content on it. In the scenarios of FIG. 4A, the computing device has disabled the dynamic adjustment system as described in FIG. 1. In scenario (a) of FIG. 4A, the user is holding the device in position 400, with the device in a landscape orientation and the display surface of the device substantially parallel to his face (e.g., if the user is sitting straight up or standing, the device is in front of his face and perpendicular to the flat ground). In some embodiments, in position 400, the computing device may not need to adjust any attributes of the displayed content or one or more settings because the device is not tilted and the user is viewing the content straight on (e.g., also, there may not be any glares due to ambient light conditions).

In scenario (b) of FIG. 4A, the user is holding the device in position 410, with the device being tilted downward so that the top of the device is closer to the user than the bottom of the device (e.g., if the user is sitting straight up or standing, the device is in front of his face, but tilted downward). In scenario (c) of FIG. 4A, the user is holding the device in position 420, with the device being tilted upward so that the top of the device is further way from the user than the bottom of the device (e.g., if the user is standing, the device is in front of his face, but tilted upward so that the display surface is partially facing upward). In position 410, display artifacts and variances can exist in the upper portion of the display (e.g., the upper portion may not be as sharp or clear or coloring may be off) due to the angular displacement of the device relative to the user. Similarly, in position 420, display artifacts can exist in various portions of the display due to the viewing angle of the user (and also due to ambient light conditions).

With the dynamic adjustment system being disabled (e.g., the user can disable the adjustment system via a user interface feature or setting), in scenarios (b) and (c), the attributes of the content in the defined region of the display area and/or the one or more global or local settings used by the display device may not be adjusted or altered. Because no dynamic adjustments are made in scenario (b) and (c), the content displayed on the display area is not as clear or sharp as the content shown in scenario (a) with the device in position 400.

FIG. 4B illustrates three scenarios, each illustrating a different way in which the user is holding and viewing content on a computing device with the dynamic adjustment system being enabled. In scenario (a) of FIG. 4B, the user is holding the device similar to scenario (a) of FIG. 4A. Even with dynamic adjustment system being enabled, no adjustments are made because the user is viewing the content straight on so that he can view the content clearly. In scenarios (b) and (c) of FIG. 4B, the devices are being held in similar positions 440, 450 as illustrated in scenarios (b) and (c), respectively, of FIG. 4A. However, because the dynamic adjustment system is enabled, the computing device corrects or compensates for the visual artifacts or variances that exist when the user holds the device in such positions. Because the content and/or the display settings are automatically adjusted (e.g., attributes of the content are adjusted in a portion, or a local display setting for a particular region of a display area can be adjusted compared to a different region of the display area), the content can be clearly displayed and shown to the user (normalized in the perspective of the user).

In some embodiments, attributes of the content can be dynamically adjusted, such as by making colors brighter, bringing out more contrast between colors and text in the content, adjusting the size of the text or altering the font, etc., based on the positioning of the device in scenarios (b) and (c) (and also based on ambient light conditions). Although the tilt is shown in only one dimension (tilted upward or downward, for example), the position of the computing device can be changed so that there are other tilts in different directions as well (e.g., tilt from left to right, or in positions in between). For example, angular displacements can arise in multiple dimensions.

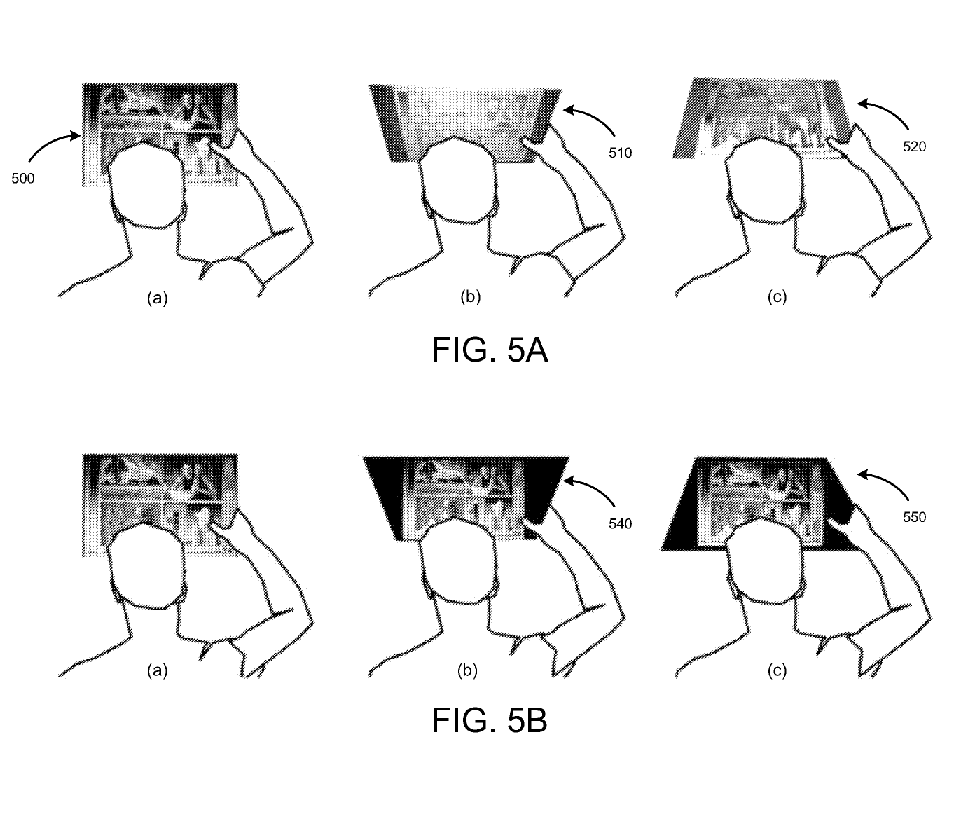

FIGS. 5A-5B illustrate dynamic adjustments performed on a computing device, under another embodiment. The exemplary illustrations of FIGS. 5A-5B represent the way a user is holding and viewing content that is provided on a display area of a computing device. The dynamic adjustments described in FIGS. 5A-5B can be performed by using the system described in FIG. 1 and methods described in FIGS. 2 and 3.

Similar to the positioning of the device in FIG. 4A, the user in FIG. 5A is holding the device in respective positions 500, 510, 520. Again, in FIG. 5A, the dynamic adjustment system is disabled. In scenario (a), the user is holding the device in position 500, with the device a landscape orientation and the front surface (display surface) of the device substantially parallel to his face. In scenario (b) of FIG. 5A, the user is holding the device in position 510 with the device being tilted downward, and in scenario (c) of FIG. 5A, the user is holding the device in position 520 with the device being tilted upward so that the top of the device is further way from the user than the bottom of the device. The content is not displayed as clearly and sharply in positions 510, 520 (compared to content as seen in position 500) as a result of the viewing angles from the tilts (and ambient light conditions, if any, causing glares, etc.) and because the dynamic adjustment system is disabled.

In FIG. 5B, the dynamic adjustment system is enabled and in scenarios (b) and (c), one or more adjustments to the attributes of the content and the display settings have been made. In one embodiment, when the device is held in position 540, the shape and size of the defined portion, e.g., the content framework, in which the content is provided is dynamically altered or configured. When the device is tilted forward in position 540, the framework in which the content is provided can be shaped as a trapezoid, for example, to offset the tilt. In this way, the visual display properties can be corrected so that the user can view the content in a normalized fashion even though the device is titled forward. For example, the content window can be adjusted so that the width of the top of the content window is smaller than the width of the bottom of the content window. The content provided in the defined portion is also scaled proportionally (to match the trapezoid shape) to correspond to the changed size and shape. In other words, the content window is displayed as a trapezoid, but in the perspective of the user when the device is held in position 540, the content would be seen as a rectangle, as if the user was holding the device in position 500 (e.g., in scenario (a)).

Similarly, in another embodiment, when the user holds the device in position 550, as seen in scenario (c), the computing device can dynamically adjust the attributes of the content and/or the display settings by making portions of the display area brighter, for example, and changing the shape and/or size of the defined portion in which the content is provided. In scenario (c), the content window can be adjusted so that the width of the top of the content window is larger than the width of the bottom of the content window, thereby creating a trapezoidal shaped content window. The content provided in the defined portion is scaled proportionally (to match the trapezoid shape) to correspond to the changed size and shape. In this way, the content window is actually displayed as a trapezoid, but in the perspective of the user when the device is held in position 550, the content would be seen as a rectangle, as if the user was holding the device in position 500 (e.g., in scenario (a)).

Hardware Diagram

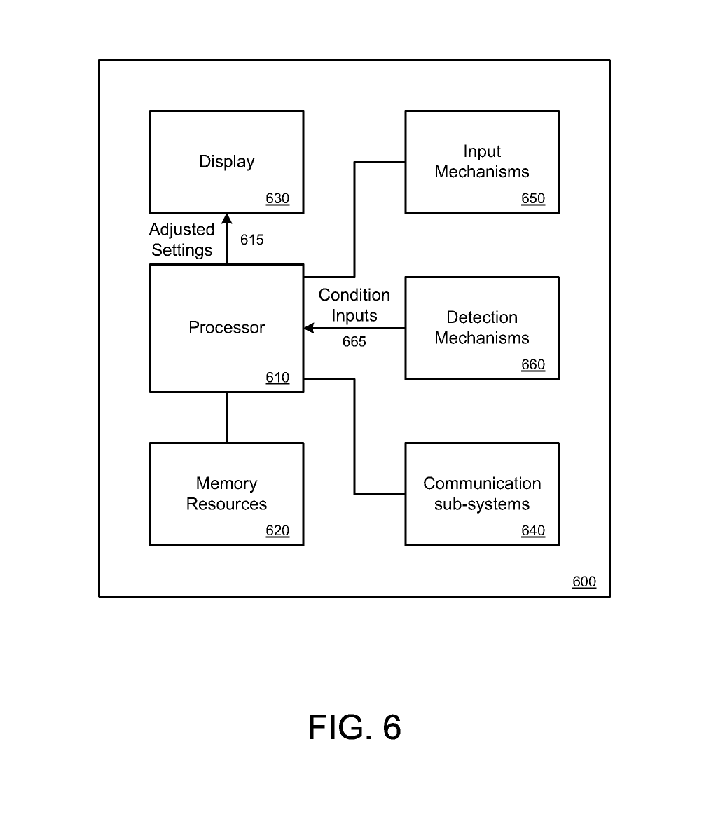

FIG. 6 illustrates an example hardware diagram that illustrates a computer system upon which embodiments described herein may be implemented. For example, in the context of FIG. 1, the system 100 may be implemented using a computer system such as described by FIG. 6. In one embodiment, a computing device 600 may correspond to a mobile computing device, such as a cellular device that is capable of telephony, messaging, and data services. Examples of such devices include smart phones, handsets or tablet devices for cellular carriers. Computing device 600 includes a processor 610, memory resources 620, a display device 630, one or more communication sub-systems 640 (including wireless communication sub-systems), input mechanisms 650, and detection mechanisms 660. In an embodiment, at least one of the communication sub-systems 640 sends and receives cellular data over data channels and voice channels.

The processor 610 is configured with software and/or other logic to perform one or more processes, steps and other functions described with embodiments, such as described by FIGS. 1-5B, and elsewhere in the application. Processor 610 is configured, with instructions and data stored in the memory resources 620, to implement the system 100 (as described with FIG. 1). For example, instructions for implementing the dynamic adjuster, the rules and heuristics, and the detection components can be stored in the memory resources 620 of the computing device 600. The processor 610 can execute instructions for operating the dynamic adjuster 110 and detection components 130, 140 and receive inputs 665 detected and provided by the detection mechanisms 660 (e.g., a camera, an accelerometer, a depth sensor). The processor 610 can adjust one or more display settings 615 used by the display device 630 and/or adjust attributes of content provided in a defined portion of a display area provided by the display device 630.

The processor 610 can provide content to the display 630 by executing instructions and/or applications that are stored in the memory resources 620. In some embodiments, the content can also be presented on another display of a connected device via a wire or wirelessly. While FIG. 6 is illustrated for a mobile computing device, one or more embodiments may be implemented on other types of devices, including full-functional computers, such as laptops and desktops (e.g., PC).

### ALTERNATIVE EMBODIMENTS

In one embodiment, the computing device can communicate with one or more other devices using a wireless communication mechanism, e.g., via Bluetooth or Wi-Fi, or by physically connecting the devices together using cables or wires. The computing device, as described in FIGS. 1-5B, can determine whether other display devices are also being used to provide content. For example, if there is a second display device (e.g., a separate LCD display) that is connected to the computing device to provide content, the computing device can determine that the second device (see e.g., FIG. 2, sub-step 216) is positioned in a certain way relative to the user.

For example, some technologies allow for a position of an object (e.g., such as a second device or second display device) to be detected at a distance away from the computing device by using ultrasonic triangulation, radio-frequency (RF) triangulation, and infrared (IR) triangulation. In one embodiment, the computing device can use ultrasonic triangulation to determine the position or location of the receiving device. In ultrasonic triangulation, the receiving device includes a speaker that emits an ultrasonic signal to the computing device. The computing device includes three or more microphones (or receptors) that receive the ultrasonic signal from the receiving device, and use the difference in timing and signal strength to determine the object's location and movement. In another embodiment, the computing device can use RF triangulation or IR triangulation to determine the position or location of the receiving device relative to the computing device. Alternatively, other methods, such as multilateration or trilateration can be used by the computing device to determine position or location information about the receiving device.

By using the position and/or orientation information of the receiving devices (e.g., by determining where the other display devices are relative to the computing device and the user or users), the computing device can adjust its display and/or content based on the determined conditions with respect to or relative to the computing device (as described in FIG. 2) and also based on information regarding the other display device. For example, the computing device can be a smart phone and the second display can be the television. The user can be sitting at a distance from the television at an angle (e.g., not sitting directly in front of the television). If content is provided by the computing device to the television (e.g., watching a video), the computing device can adjust its display device and also the television, in the manner discussed in this application, to create a visually coherent display cluster from the user's perspective.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for providing content on a computing device, the method being performed by one or more processors and comprising:
providing content, from execution of an application, in a defined portion of a display area provided by a display device of the computing device, the defined portion including a first set of attributes; and
altering one or more attributes of the first set of attributes based on one or more inputs detected by one or more sensors, the one or more attributes being altered independent of a set of global settings used by the display device to provide the display area.

2. The method of claim 1, wherein altering the one or more attributes includes determining a position and/or an orientation of the computing device relative to a user's head using the one or more inputs detected by the one or more sensors.

3. The method of claim 2, wherein altering the one or more attributes includes using one or more rules stored in a database.

4. The method of claim 2, wherein altering the one or more attributes includes (i) changing a size and/or a shape of the defined portion in which the content is provided, and (ii) proportionally scaling the content in a manner corresponding to the changed size and/or shape of the defined portion.

5. The method of claim 4, wherein the one or more inputs includes ambient light conditions surrounding the computing device, the ambient light conditions including intensities, directions, and/or type of one or more ambient light sources.

6. The method of claim 5, wherein altering the one or more attributes includes determining one or more angles in which light from the one or more ambient light sources is exposed to a surface of the display area.

7. The method of claim 2, further comprising altering one or more settings of the global set of settings used by the display device of at least a region of the display area based on the one or more inputs detected by the one or more sensors.

8. The method of claim 7, wherein the one or more settings includes brightness, contrast, color saturation, color tint, color tone, sharpness, resolution, reflectivity, or transparency.

9. A computing device comprising:
a display device that provides a display area;
one or more sensors; and
a processor coupled to the display device and the one or more sensors, the processor to:
provide content, from execution of an application, in a defined portion of the display area provided by the display device, the defined portion including a first set of attributes; and
alter one or more attributes in the first set of attributes based on one or more inputs detected by the one or more sensors, the one or more attributes being altered independent of a set of global settings used by the display device to provide the display area.

10. The computing device of claim 9, wherein the processor alters the one or more attributes by determining a position and/or an orientation of the computing device relative to a user's head using the one or more inputs detected by the one or more sensors.

11. The computing device of claim 10, wherein the processor alters the one or more attributes by using one or more rules stored in a database.

12. The computing device of claim 10, wherein the processor alters the one or more attributes by (i) changing a size and/or a shape of the defined portion in which the content is provided, and (ii) proportionally scaling the content in a manner corresponding to the changed size and/or shape of the defined portion.

13. The computing device of claim 12, wherein the one or more inputs includes ambient light conditions surrounding the computing device, the ambient light conditions including intensities, directions, and/or type of one or more ambient light sources, and wherein the processor alters the one or more attributes by determining one or more angles in which light from the one or more ambient light sources is exposed to a surface of the display area.

14. The computing device of claim 10, wherein the processor further alters one or more settings of the global set of settings used by the display device of at least a region of the display area based on the one or more inputs detected by the one or more sensors, and wherein the one or more settings includes brightness, contrast, color saturation, color tint, color tone, sharpness, resolution, reflectivity, or transparency.

15. A non-transitory computer readable medium storing instructions that, when executed by a processor, cause the processor to perform steps comprising:
providing content, from execution of an application, in a defined portion of a display area provided by a display device of the computing device, the defined portion including a first set of attributes; and
altering one or more attributes in the first set of attributes based on one or more inputs detected by one or more sensors, the one or more attributes being altered independent of a global set of settings used by the display device to provide the display area.
